(19) United States
(12) Patent Application Publication
(10) Pub. No.: US 2013/0124050 A1
(43) Pub. Date: May 16, 2013

(54) APPARATUS AND METHOD FOR OPERATING PRE-CRASH DEVICE FOR VEHICLE

(71) Applicants: Sang Min Jo, Hwaseong-si (KR); Yong-Sun Kim, Namyangju-si (KR); Seoung Hoon Lee, Suwon-si (KR)

(72) Inventors: Sang Min Jo, Hwaseong-si (KR); Yong-Sun Kim, Namyangju-si (KR); Seoung Hoon Lee, Suwon-si (KR)

(73) Assignees: Kia Motors Corp., Seoul (KR); Hyundai Motor Company, Seoul (KR)

(21) Appl. No.: 13/492,644

(22) Filed: Jun. 8, 2012

(30) Foreign Application Priority Data
Nov. 15, 2011 (KR) 10-2011-0119034

(51) Int. Cl. B60R 21/0132; B60R 21/36

(52) U.S. Cl. 701/45

(57) ABSTRACT

A pre-crash operating device for a vehicle includes a scanning sensor unit for scanning objects around the vehicle by using laser, a sensor unit of the vehicle for sensing driving information including a velocity, an acceleration, an steering angle, yaw rate and a brake pressure, a safety device unit to be actuated prior to a collision and to protect occupant, and a control unit for computing an offset value and a relative velocity between the vehicle and the object by using the driving information from the scanning unit and the sensor unit of the vehicle, thereby selecting an object as an imminent collision object and actuating the safety device when a predicted collision time induced from the relative velocity of the imminent collision object is within a predetermined time.

### CROSS-REFERENCE TO RELATED APPLICATION

The present application claims priority of Korean Patent Application Number 10-2011-0119034 filed Nov. 15, 2011, the entire contents of which application is incorporated herein for all purposes by this reference.

### BACKGROUND OF INVENTION

1. Field of Invention

The present invention relates to an apparatus and a method for managing a pre-crash device for a vehicle, capable of predicting the courses of a vehicle and a target-object and a relative velocity and operating a safety device in advance in order to protect occupants to the fullest when a collision accident occurs.

2. Description of Related Art

Recently, a pre-crash concept appears as a regulation of vehicle safety has been reinforced. That is, the pre-crash relates to a technology for protecting occupants more actively than prior technologies such as an air-bag or a seat belt by predicting a collision of a vehicle and operating safety device in advance to reduce an collision impact when an accident occurs.

To realize the pre-crash it is important to determine whether to deploy a safety device or not, and for this purpose, a logic for sensing and deploying of the safety device is necessary.

A sensor may have an ability to distinguish target-object for deployment and non-deployment. Further, the sensor should have a suitable search range for deploying the safety device such as an external-air-bag and should not be influenced by environment/weather.

A logic of development method of an air-bag, unlike a prior deployment method of an air-bag on a driver's seat, it may determine whether to deploy an air bag or not using a sensor measurement value of a target-object before a collision. Furthermore, it needs to determine whether to deploy an external air bag or not before sensing a physical collision.

Accordingly, to solve the above-mentioned drawbacks, it is important how the sensor distinguish and sense the target-object well, and in the case of the deployment method, it is the core of this technology whether to determine deploying an airbag on time or not before the collision.

So far there's no solution to predict a collision situation using this sensing technology and information and to timing technique of deploying an air bag against the collision situation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an apparatus of a pre-crash device for a vehicle and a method thereof for measuring precisely and predicting a path and a velocity of an target-object to sense a collision situation in advance, thereby deploying a safety device properly to protect occupants to the fullest.

Various aspects of the present invention provide for a pre-crash operating device for a vehicle including a scanning sensor unit for scanning objects around the vehicle, a sensor unit of the vehicle for sensing drive information including a velocity, an acceleration, an steering angle, yaw rate and a brake pressure, a safety device unit to be actuated prior to a collision and to protect occupant, and a control unit for computing offset value and relative velocity between the vehicle and the object by using the driving information from the sensor unit of the vehicle, thereby determining an imminent collision object and actuating the safety device when a predicted collision time induced from the relative velocity of the imminent collision object is within a predetermined time.

The safety device is an external air bag of a vehicle and the predetermined time is a deployment time of the external air bag.

The control unit recognizes a contour and a central point location of the object by using the scanned information from the scanning unit, computes and predicts the offset value between the vehicle and the object by using the contour of the object, and computes and predicts the velocity of the object by using of the central point location.

The control unit computes the present offset value between the vehicle and an object by using a contour of the object and predicts the following offset value by using a contour displacement.

The control unit computes the velocity of the object through a location displacement of the central point of the object by using received information from the scanning sensor unit, computes an acceleration of the object by using the velocity gradient of the object and predicts a following velocity of the object by using the acceleration of the object.

The control unit predicts the following velocity of the vehicle by using the acceleration and the brake pressure of the driving information received from the sensor unit of the vehicle, computes the present path of the vehicle by using the steering angle and the yaw rate displacement and predicts the following path by using the velocity and the present path.

The control unit selects an object having the largest offset value and the largest relative velocity as an imminent collision object wherein the control unit selects an object having the larger relative velocity than those of others as an imminent collision object when imminent collision objects are different, based on two of the offset value and relative velocity, thereby actuates the safety device when the predicted collision time is within a predetermined time.

Various aspects of the present invention provide for an operating method of a pre-crash device for a vehicle including sensing drive information including a velocity, an acceleration, an steering angle, yaw rate and a brake pressure, figuring out a vehicle state through computing and predicting the velocity and the path of the vehicle by using the driving information, scanning objects around the vehicle by using laser of the scanning sensor unit, distinguishing objects through computing and predicting the contour, the path and the velocity of the object by using scanned information of the object, predicting the offset value by using the path prediction between the vehicle and the object and the relative velocity by using the velocity prediction of the vehicle and the object, selecting an object an imminent collision object by comparing the predicted offset value and the relative velocity, and

actuating the safety device unit when a predicted collision time induced from the relative velocity of the imminent collision object is within a predetermined time.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conceptual view of an exemplary pre-crash operating device and an operation method thereof in accordance with the present invention.

FIG. 2 is a block diagram of an exemplary pre-crash operating device in accordance with the present invention.

FIG. 3 is a flow chart of an operation method of an exemplary pre-crash operating device in accordance with the present invention.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

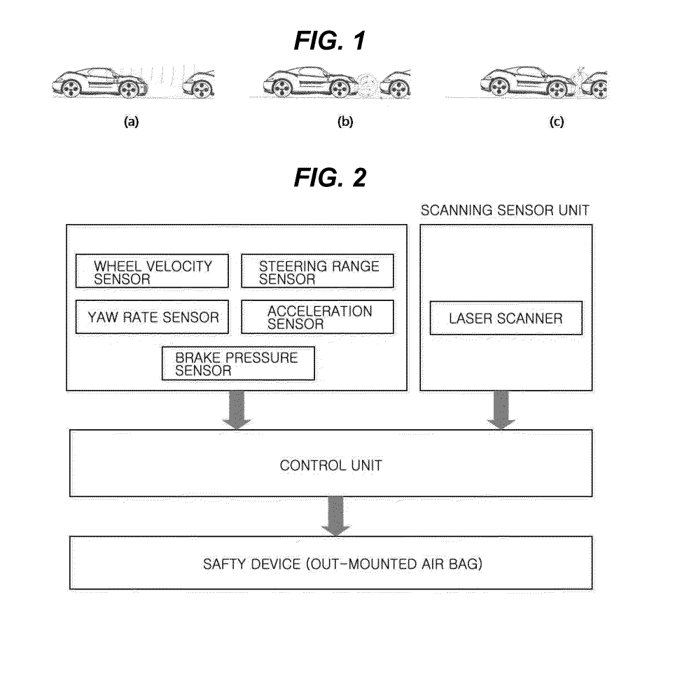

FIG. 1 is a conceptual view of a pre-crash operating device and an operation method thereof in accordance with various embodiments of the invention, wherein a typical example of pre-crash is conceptualized as (a) sensing objects around a vehicle, (b) distinguishing a high risky object among sensed objects and deploying a safety device prior to an imminent collision, and (c) absorbing the impact applied to the vehicle through the safety device deployed in advance. That is, in this technology of pre-crash, the first priority is determination of an object, prediction of a collision and proper deployment of a safety device, and a typical example is an external air bag.

FIG. 2 is a block diagram of a pre-crash operating device in accordance with various embodiments of this invention, wherein the pre-crash operating device for a vehicle includes a scanning sensor unit for scanning objects around the vehicle using laser, a sensor unit of the vehicle for sensing drive information including a velocity, an acceleration, an steering angle, yaw rate and a brake pressure, a safety device unit to be actuated prior to a collision and protect occupant during a collision, and a control unit for computing offset value and relative velocity between the vehicle and the object using the drive information of the scanning unit and the sensor unit of the vehicle, thereby determining an imminent collision object and actuating the safety device when a predicted collision time induced from the relative velocity of the imminent collision object is within a predetermined time. Further, the safety device may be an external air bag of a vehicle and the predetermined time may be a deployment time of the external air bag, and hereinafter descriptions will be given, referring to the external air bag.

The scanning sensor unit of the vehicle scans objects around the vehicle, sensing a contour and displacement of surrounding objects on real time through rotating laser around the vehicle. The laser sensor may be operated in various environments and be used as a most suitable sensing device.

Meanwhile, the vehicle is provided with sensors for collecting various informations in related to driving a vehicle. The sensor unit according to the present invention collects driving information including a velocity, an acceleration, an steering angle, yaw rate and a brake pressure. In the present invention, the driving information to be determined by prior sensors of a vehicle may be used as itself.

The control unit according to the present invention collects the information and distinguishes objects, selects highly dangerous object and determines the time for deploying an air bag.

Further, the control unit computes an offset value and a relative velocity between the vehicle and the object using the driving information from the scanning unit and the sensor unit of the vehicle, thereby selecting an imminent collision object and actuating the safety device when a predicted collision time induced from the relative velocity of the imminent collision object is within a predetermined time. In the case of an external air bag, when the predicted collision time is narrowed gradually and arrives at a deployment time of the external air bag, the control unit allows the external air bag to be deployed in advance and a collision to be occurred when the external air bag is deployed completely.

Meanwhile, the control unit may recognize a contour and a central point location of the object using the scanned information from the scanning unit, compute and predict the offset value between the vehicle and the object using the contour of the object and compute and predict a velocity of the object using a location of the central point. Further, the control unit may compute the current offset value between the vehicle and an object using a contour of the object and predict the following offset value using the contour displacement.

Further, the control unit may compute the velocity of the object through a location displacement of the center point of the object using scanning information from the scanning sensor unit, compute an acceleration of the object using the velocity gradient of the object and predict a following velocity of the object using the acceleration of the object.

That is, the control unit recognizes contours and central point locations of surrounding objects using scanned information from the scanning unit and computes the offset value against the vehicle using the position of the contours. Further, the control unit computes and predicts the velocity and the following location of the object using displacement of the central point. Further, the control unit computes and predicts the following offset value using the displacement of the contour.

Meanwhile, the control unit may predict the following velocity value of the vehicle using the acceleration and the brake pressure of drive information received from the sensor unit of the vehicle, compute the present path of the vehicle using the steering angle and the yaw rate displacement and predict the following path using the following velocity value and the present path.

As a result, the control unit predicts the following offset value and the relative velocity between the vehicle and the target-object.

After that, the control unit selects an object having the largest offset value and the largest relative velocity as an imminent collision object wherein the control unit selects an obect having the larger relative velocity than those of others as an imminent collision object when the imminent collision objects are different based on the largest offset value and the largest relative velocity, thereby actuate the safety device when a predicted collision time is within a predetermined time based on the object.

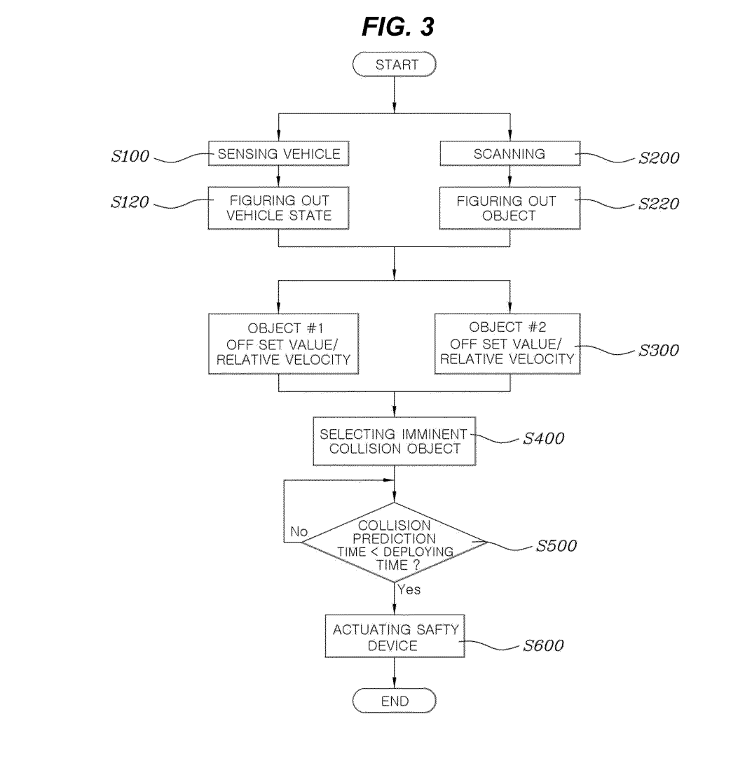

FIG. 3 is a flow chart of an operation method of a pre-crash operating device in accordance with various embodiments of the present invention. The operation method according to the present invention includes sensing vehicle driving information such as a velocity, an acceleration, an steering angle, yaw rate and a brake pressure from a sensor unit of the vehicle S100, figuring out a vehicle state through computing and predicting the velocity and the path of the vehicle using the vehicle driving information S120, scanning objects around the vehicle with laser using a scanning sensor unit S200, recognizing objects through computing and predicting the contour, path and velocity of surrounding objects using scanned information of the object S220, predicting the offset value using the path prediction between the vehicle and the object and predicting the relative velocity using the velocity prediction of the vehicle and the object S300, selecting an imminent collision object comparing the predicted offset value and the relative velocity S400, and actuating the safety device unit when a predicted collision time Induced from the relative velocity of the imminent collision object is within a predetermined time S500, S600.

Specifically, the figuring out the behaviors of the object and the vehicle should be performed at the same time. That is, the driving information including a velocity, an acceleration, an steering angle, yaw rate and a brake pressure is sensed from a sensor unit of the vehicle, thereby the velocity and the path of the vehicle are computed and predicted.

Meanwhile, objects around the vehicle are sensed with laser and at the same time contour, path and velocity of surrounding objects are computed and predicted using scanned information data.

After the offset value is predicted using the path and the velocity prediction between the vehicle and the object and the relative velocity is predicted using the velocity prediction of the vehicle and the object, an imminent collision object is selected by comparing the predicted offset value and the relative velocity, and the safety device unit is actuated when a predicted collision time induced from the relative velocity of the imminent collision object is within a predetermined time so that a necessary time for deploying the external air bag is ensured in advance prior to the collision and the occupant is fully protected.

According to the apparatus of pre-crash device for a vehicle and the method thereof, it is able to measure precisely and predict a path and velocity of a target- object to sense a collision situation in advance, thereby actuate the safety device properly to protect occupants to the fullest.

In addition, the behaviors of the object and the vehicle have a priority through the offset value and the relative velocity, thereby actuate the safety device in advance with regard to the time to take in deploying the safety device so as to have the maximum effect.

An external air bag is very suitable to achieve various purposes of the present invention.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pre-crash operating device for a vehicle comprising:
a scanning sensor unit for scanning objects around the vehicle;
a sensor unit for sensing drive information of the vehicle including a velocity, an acceleration, an steering angle, a yaw rate and a brake pressure;
a safety device unit to be actuated prior to a collision and to protect occupant; and
a control unit for computing offset value and relative velocity between the vehicle and the object by using the driving information from the sensor unit of the vehicle, thereby determining an imminent collision object and actuating the safety device when a predicted collision time induced from the relative velocity of the imminent collision object is within a predetermined time.

2. The pre-crash operating device for a vehicle of claim 1, wherein the safety device is an external air bag of a vehicle and the predetermined time is a deployment time of the external air bag.

3. The pre-crash operating device for a vehicle of claim 1, wherein the control unit recognizes a contour and a central point location of the object by using the scanned information from the scanning unit, computes and predicts the offset value between the vehicle and the object by using the contour of the object, and computes and predicts the velocity of the object by using of the central point location.

4. The pre-crash operating device for a vehicle of claim 3, wherein the control unit computes the present offset value between the vehicle and an object by using a contour of the object and predicts the following offset value by using a contour displacement.

5. The pre-crash operating device for a vehicle of claim 1, wherein the control unit computes the velocity of the object through a location displacement of the central point of the object by using received information from the scanning sensor unit, computes an acceleration of the object by using the velocity gradient of the object and predicts a following velocity of the object by using the acceleration of the object.

6. The pre-crash operating device for a vehicle of claim 1, wherein the control unit predicts the following velocity of the vehicle by using the acceleration and the brake pressure of the driving information received from the sensor unit of the vehicle, computes the present path of the vehicle by using the steering angle and the yaw rate displacement and predicts the following path by using the velocity and the present path.

7. The pre-crash operating device for a vehicle of claim 1, wherein the control unit selects an object having the largest offset value and the largest relative velocity as an imminent collision object wherein the control unit selects an object having the larger relative velocity than those of others as an imminent collision object when imminent collision objects are different, based on two of the offset value and relative velocity, thereby actuates the safety device when the predicted collision time is within a predetermined time.

8. A operating method of a pre-crash device for a vehicle comprising:
sensing drive information including a velocity, an acceleration, an steering angle, a yaw rate and a brake pressure;
figuring out a vehicle state through computing and predicting the velocity and the path of the vehicle by using the driving information;
scanning objects around the vehicle by using laser of the scanning sensor unit;
distinguishing objects through computing and predicting the contour, the path and the velocity of the object by using scanned information of the object;
predicting the offset value by using the path prediction between the vehicle and the object and the relative velocity by using the velocity prediction of the vehicle and the object;
selecting an object an imminent collision object by comparing the predicted offset value and the relative velocity; and
actuating the safety device unit when a predicted collision time induced from the relative velocity of the imminent collision object is within a predetermined time.
